(19) United States
(12) Patent Application Publication
(10) Pub. No.: US 2025/0027633 A1
(43) Pub. Date: Jan. 23, 2025

(54) LIQUID CRYSTAL ELEMENT AND LIGHTING APPARATUS

(71) Applicant: STANLEY ELECTRIC CO., LTD., Meguro-ku, Tokyo (JP)

(72) Inventors: Yasuo TOKO, Tokyo (JP); Yoshihisa IWAMOTO, Tokyo (JP)

(73) Assignee: STANLEY ELECTRIC CO., LTD., Meguro-ku, Tokyo (JP)

(21) Appl. No.: 18/715,321

(22) PCT Filed: Nov. 17, 2022
(86) PCT No.: PCT/JP2022/042712

§ 371 Date: May 31, 2024

(30) Foreign Application Priority Data
Dec. 3, 2021 (JP) 2021-196774

(51) Int. Cl. F21V 14/00; G02F 1/1333; G02F 1/1343

(52) U.S. Cl. CPC F21V 14/003; G02F 1/133345; G02F 1/134309

(57) ABSTRACT

A liquid crystal element includes: a first substrate, a second substrate, and a liquid crystal layer arranged therebetween; auxiliary electrodes arranged on the first substrate; an insulation layer arranged covering a plurality of first electrodes; a plurality of pixel electrodes arranged between the insulation layer and the liquid crystal layer; and a counter electrode arranged on the second substrate; where the pixel electrodes are arranged with a gap provided therebetween in one direction, where the auxiliary electrodes are arranged to respectively overlap with the gap between the adjacent pixel electrodes, and is connected to the adjacent pixel electrodes through a contact hole provided in the insulation layer, and where the insulation layer has an opening part in a portion corresponding to the gap between the adjacent pixel electrodes.

### TECHNICAL FIELD

The present disclosure relates to a liquid crystal element and a lighting apparatus.

### BACKGROUND ART

Japanese Unexamined Patent Application Publication No. 2020-154153 (Patent Document 1) discloses a lighting apparatus configured using a liquid crystal element. This liquid crystal element includes: a first substrate, a second substrate and a liquid crystal layer; a counter electrode provided on the first substrate; a plurality of inter-pixel electrodes provided on the second substrate; a first insulation layer provided on the upper side of the plurality of inter-pixel electrodes; a plurality of pixel electrodes provided on the upper side of the first insulation layer; and a second insulation layer provided on the upper side of the plurality of pixel electrodes; where the plurality of pixel electrodes are being arranged with gaps provided therebetween at least along a first direction in a plane view, where the plurality of inter-pixel electrodes are respectively arranged so as to overlap the gap between the two adjacent pixel electrodes in the first direction in a plane view and are respectively connected to one of the two pixel electrodes, where the second insulation layer is selectively provided in each region overlapping with each of the plurality of pixel electrodes in a plane view. By using this liquid crystal element, it is possible to enhance the appearance of a light distribution pattern in the lighting apparatus.

However, the liquid crystal element used in the above-described lighting apparatus needs to have two insulation layers which are the first insulation layer and the second insulation layer, and with regard to the second insulation layer, it needs to be provided so as to overlap each pixel electrode with high accuracy, thereby there is room for improvement in that the manufacturing process becomes complicated.

### PRIOR ART DOCUMENT

### Patent Document

[Patent Document 1] Japanese Unexamined Patent Application Publication No. 2020-154153

### SUMMARY OF THE INVENTION

### Technical Problem

In a specific aspect, in a liquid crystal element used in a lighting apparatus in which light distribution pattern can be freely controlled, it is an object of the present disclosure to provide a technique that makes it possible to enhance the appearance of the light distribution pattern while simplifying the manufacturing process of the liquid crystal element.

### Solution to the Problem

(1) A liquid crystal element according to one aspect of the present disclosure is a liquid crystal element including: (a) a first substrate and a second substrate arranged to face each other; (b) a liquid crystal layer arranged between the first substrate and the second substrate; (c) a plurality of auxiliary electrodes arranged on one surface side of the first substrate facing the liquid crystal layer; (d) an insulation layer arranged on the one surface side of the first substrate so as to cover the plurality of first electrodes; (e) a plurality of pixel electrodes arranged between the insulation layer of the first substrate and the liquid crystal layer; and (f) a counter electrode arranged on one surface side of the second substrate facing the liquid crystal layer; (g) where the plurality of pixel electrodes are being arranged with gaps provided therebetween in at least one direction in a plane view; (h) where the plurality of auxiliary electrodes is being arranged so as to respectively overlap with the gap between the adjacent pixel electrodes in a plane view, and is connected to one of the adjacent pixel electrodes via a contact hole provided in the insulation layer; and (i) where the insulation layer has an opening part at least in a portion corresponding to the gap between the adjacent pixel electrodes.

(2) A lighting apparatus according to one aspect of the present disclosure is a lighting apparatus including: (a) a liquid crystal element according to the above-described (1); (b) a light source that causes light to enter the liquid crystal element; and (c) a lens that condenses the light that passes through the liquid crystal element.

According to the above configurations, in a liquid crystal element used in a lighting apparatus in which light distribution pattern can be freely controlled, it is possible to provide a technique that enables to enhance the appearance of the light distribution pattern while simplifying the manufacturing process of the liquid crystal element.

### BRIEF DESCRIPTION OF THE DRAWINGS

FIG. 1 is a diagram showing the configuration of a vehicle lighting system according to one embodiment.

FIG. 2A and FIG. 2B are schematic cross-sectional views showing the configuration of a liquid crystal element.

FIG. 3 is a plane view for explaining the configurations of each pixel electrode, each inter-pixel electrode, and each wiring part.

FIG. 4A and FIG. 4B are each a schematic cross-sectional view showing the configuration of a liquid crystal element of a modified working example.

FIG. 5A to FIG. 5D are diagrams for explaining a manufacturing method of a liquid crystal element.

FIG. 6A and FIG. 6B are diagrams for explaining a manufacturing method of a liquid crystal element.

FIG. 7A and FIG. 7B are each a schematic cross-sectional view showing the configuration of a first substrate of a liquid crystal element of a modified working example.

FIG. 8A is a diagram for explaining measurement points (measurement locations) of electro-optical characteristics of a liquid crystal element.

FIG. 8B is a diagram showing a measurement example of the electro-optical characteristics.

FIG. 9A and FIG. 9B are diagrams showing measurement examples of electro-optical characteristics of liquid crystal elements of modified working examples in which the insulation layer (thin layer part) is caused to remain (refer to FIG. 7A).

### MODE FOR CARRYING OUT THE INVENTION

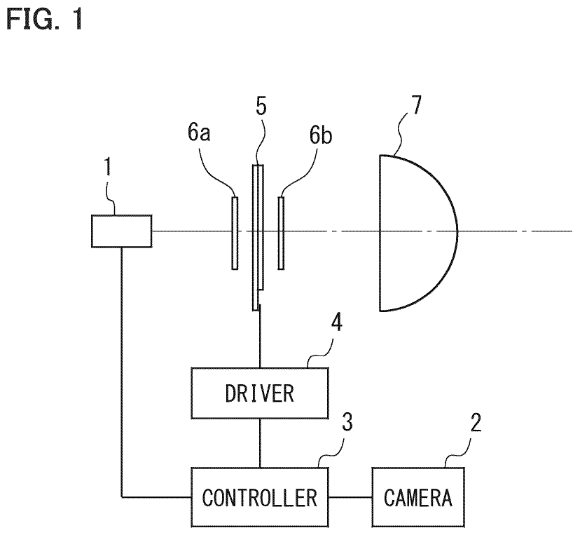

FIG. 1 is a diagram showing the configuration of a vehicle lighting system according to one embodiment. The vehicle lighting system shown in FIG. 1 is configured to include a light source 1, a camera 2, a controller (control apparatus) 3, a driver (liquid crystal driving apparatus) 4, a liquid crystal element 5, a pair of polarizers 6a and 6b, and a projection lens 7. This vehicle lighting system detects a position of a vehicle in front, pedestrians, etc. existing around the own vehicle based on images taken by the camera 2, sets a certain range including the position of the vehicle in front, etc. as a light dimming range (or a non-irradiation range) and sets the other range as a light irradiation range, and performs selective light irradiation.

The light source 1 is configured to include a white light LED configured by combining a light emitting element (LED) that emits blue color light with a yellow color phosphor, for example. The light source 1 has a plurality of white light LEDs arranged in a matrix or a line, for example. Here, as the light source 1, in addition to LEDs, lasers, and light sources commonly used in a vehicle lamp unit such as light bulbs and discharge lamps can be used. The on/off state of the light source 1 is controlled by the controller 3. Light emitting from the light source 1 enters the liquid crystal element (liquid crystal panel) 5 via the polarizer 6a. Here, note that another optical system (for example, a lens, a reflecting mirror, and a combination thereof) may exist on the path from the light source 1 to the liquid crystal element 5.

The camera 2 is for photographing the front of the own vehicle and outputting the image (information), and is arranged at a predetermined position within the own vehicle (for example, at the upper inner side of the windshield). Here, note that if the own vehicle is equipped with a camera for other purposes (for example, an automatic braking system, etc.), the camera may be shared.

The controller 3 detects the position of the vehicle in front by performing image processing based on the image obtained by the camera 2 that photographs the front of the own vehicle, establishes a light distribution pattern in which a certain range including the detected position of the vehicle in front, etc. is set as a non-irradiation range and the other range is set as the light irradiation range, generates a control signal for forming an image corresponding to the light distribution pattern, and supplies the control signal to the liquid crystal driving circuit 4. This controller 3 is realized by executing a predetermined operating program in a computer system having a CPU, ROM, RAM, etc., for example.

The driver 4 individually controls the alignment state of the liquid crystal layer in each pixel region of the liquid crystal element 5 by supplying a driving voltage to the liquid crystal element 5 based on the control signal supplied from the controller 3.

The liquid crystal element 5 has a plurality of pixel regions (light modulation regions) in which each can be controlled individually, and the transmittance of each pixel region is being variably set depending on the magnitude of the voltage applied to the liquid crystal layer by the driver 4. By having light from the light source 1 irradiated to the liquid crystal element 5, an image having light and dark contrast corresponding to the above-described light irradiation range and light dimming range is formed. For example, the liquid crystal element 5 includes a vertically aligned type liquid crystal layer and is arranged between the pair of polarizers 6a and 6b arranged in a crossed-Nicol arrangement, light transmittance becomes extremely low (light shielding state) when no voltage (or a voltage at or below a threshold) is applied to the liquid crystal layer, and the light transmittance becomes relatively high (transmissive state) when a voltage is applied to the liquid crystal layer.

The pair of polarizers 6a and 6b have their polarization axes substantially perpendicular to each other, and are disposed facing each other with the liquid crystal element 5 in between, for example. In the present embodiment, a normally black mode is assumed, which is an operation mode in which light is blocked (transmittance is extremely low) when no voltage is applied to the liquid crystal layer. As each of the polarizers 6a, 6b, an absorption type polarizer made of general organic material (iodine type, dye type) can be used, for example. Furthermore, if heat resistance is essential, it is also preferable to use a wire grid type polarizer. A wire grid type polarizer is a polarizer made of an array of ultrafine wires made of metal such as aluminum. Further, an absorption type polarizer and a wire grid type polarizer may be stacked and used.

The projection lens 7 spreads an image formed by the light passing through the liquid crystal element 5 (an image having light and dark contrast corresponding to the light irradiation range and the light dimming range) to match the light distribution for headlights and projects it in front of the own vehicle, and an appropriately designed lens is used. In the present embodiment, an inverted projection type projector lens is used.

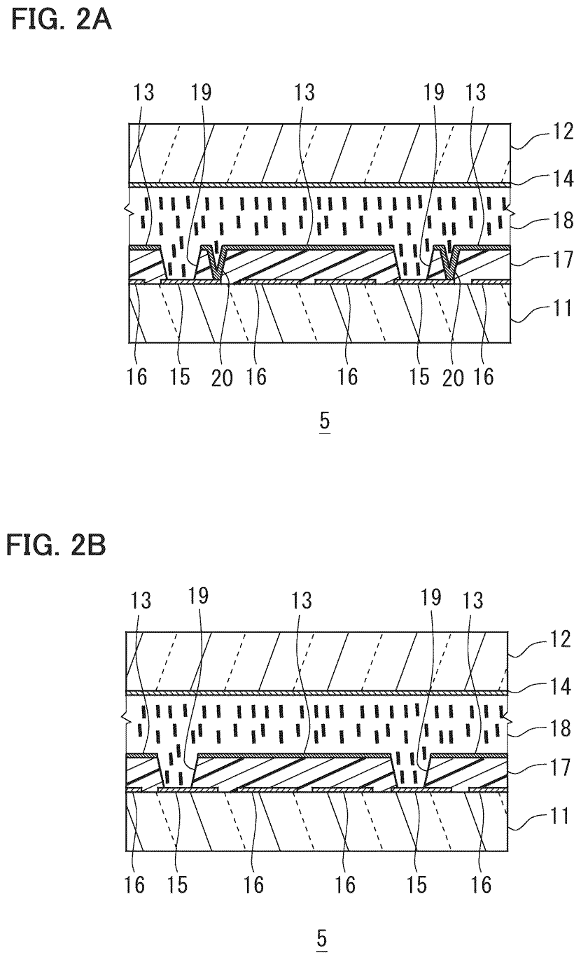

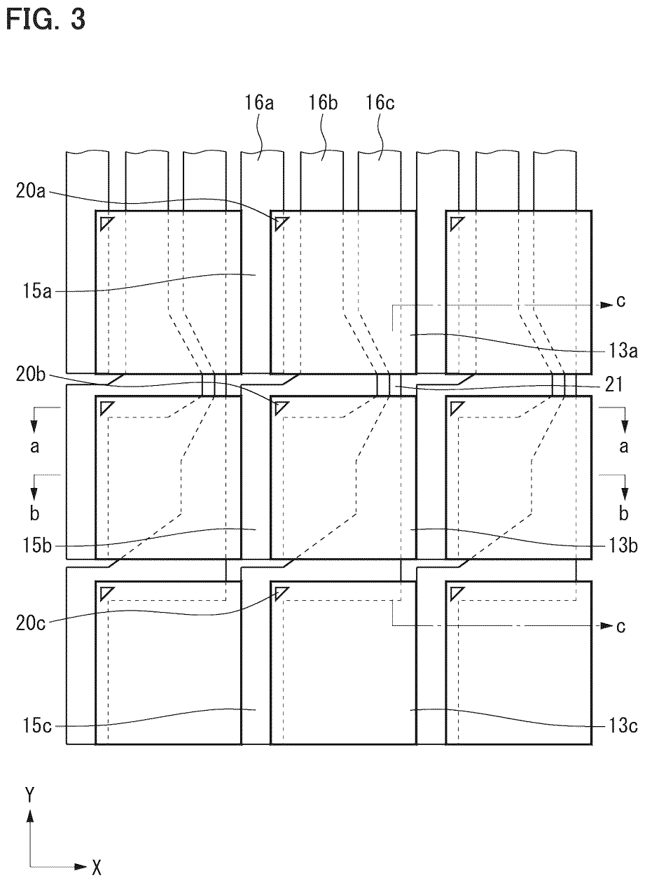

FIG. 2A and FIG. 2B are schematic cross-sectional views showing the configuration of a liquid crystal element. Further, FIG. 3 is a plane view for explaining the configurations of each pixel electrode, each inter-pixel electrode, and each wiring part. Here, note that the cross-sectional view shown in FIG. 2A corresponds to a partial cross-section taken along line a-a shown in FIG. 3, and the cross-sectional view shown in FIG. 2B corresponds to a partial cross-section taken along line b-b shown in FIG. 3.

The liquid crystal element 5 is configured to include a first substrate 11, a second substrate 12, a plurality of pixel electrodes 13, a common electrode (counter electrode) 14, a plurality of inter-pixel electrodes (auxiliary electrodes) 15, a plurality of wiring parts 16, an insulation layer (insulation film) 17 and a liquid crystal layer 18.

The first substrate 11 and the second substrate 12 are each a rectangular substrate in a plane view, for example, and are arranged to face each other. As each substrate, a transparent substrate such as a glass substrate or a plastic substrate can be used, for example. Between the first substrate 11 and the second substrate 12, for example, spherical spacers (not shown) made of resin film, etc. are distributed, and a gap between the substrates of a desired size (for example, on the order of several μm) is maintained by these spherical spacers. Here, note that instead of the spherical spacers, columnar bodies made of resin or the like may be provided on the first substrate 11 side or the second substrate 12 side and used as spacers.

The plurality of pixel electrodes 13 are provided on one surface of the insulation layer 17 (the surface side in contact with the liquid crystal layer 18) on one surface side of the first substrate 11. Each pixel electrode 13 is physically and electrically connected to one inter-pixel electrode 15 and one wiring part 16 connected to this inter-pixel electrode via a through hole 20 provided in the insulation layer 17. Each pixel electrode 13 is configured by appropriately patterning a transparent conductive film such as indium tin oxide (ITO). Each pixel electrode 13 has a rectangular outer edge shape in a plane view, for example, and is arranged in a matrix along the X direction and the Y direction. A gap is provided between each pixel electrode 13.

The common electrode 14 is provided on one surface side of the first substrate 11. This common electrode 14 is integrally provided so as to face each pixel electrode 13 of the second substrate 12. The common electrode 14 is configured by appropriately patterning a transparent conductive film such as indium tin oxide (ITO). A pixel region (light modulation region) is configured in each region where this common electrode 14 and each pixel electrode 13 overlap.

The plurality of inter-pixel electrodes 15 are provided between one surface side of the first substrate 11 and the insulation layer 17. Each circular-pixel electrode 15 is arranged so as to overlap the gap between adjacent pixel electrodes 13 in a plane view. Each inter-pixel electrode 15 is configured by appropriately patterning a transparent conductive film such as indium tin oxide (ITO).

The plurality of wiring parts 16 are provided between one surface side of the first substrate 11 and the insulation layer 17. Each wiring part 16 is arranged so as to overlap each pixel electrode 13 in a plane view. Each wiring part 16 is configured by appropriately patterning a transparent conductive film such as indium tin oxide (ITO). Each wiring part 16 is for applying voltage from the driver 4 to each pixel electrode 13.

The insulation layer 17 is provided on one surface side of the first substrate 11 so as to cover each inter-pixel electrode 15 and each wiring part 16. The insulation layer 17 has an opening part 19 at least in a portion corresponding to each inter-pixel electrode 15. In the present embodiment, the insulation layer 17 is provided at a range corresponding to each pixel electrode 13, and the entire portions between the pixel electrodes 13 are for opening parts 19. The insulation layer 17 has a shape in a plane view such that the end position of each pixel electrode 13 and the end position of the insulation, etc. 17 approximately coincide with each other at the portion overlapping each pixel electrode 13. The insulation layer 17 is, for example, a SiNx film, a SiO2 film, or a SiON film, and can be formed by a gas phase process such as a sputtering method or a solution process. Here, note that an organic insulation film may be used as the insulation layer 17. The layer thickness of the insulation layer 17 is about 1 μm, for example.

The liquid crystal layer 18 is provided between the first substrate 11 and the second substrate 12. In the present embodiment, the liquid crystal layer 18 is configured using a nematic liquid crystal material having negative dielectric anisotropy Δε, containing a chiral material, and having fluidity. In the liquid crystal layer 18 of the present embodiment, the alignment direction of liquid crystal molecules is tilted in one direction when no voltage is applied, and its alignment is set to be approximately vertical having a pretilt angle in the range of 85° or more and less than 90° with respect to each substrate surface, for example.

Although not shown, an alignment film is provided on one surface side of the first substrate 11 so as to cover each pixel electrode 13, and an alignment film is provided on one surface side of the second substrate 12 so as to cover the common electrode 14. In the present embodiment, as each alignment film, a vertical alignment film that regulates the alignment state of the liquid crystal layer 18 to a vertical alignment is used. Each alignment film is subjected to a uniaxial alignment process such as a rubbing process, and has a uniaxial alignment regulating force that regulates the alignment of liquid crystal molecules in the liquid crystal layer 18 in that direction. The direction of the alignment treatment on each alignment film is set to be alternate (anti-parallel), for example. The film thickness of each alignment film is 50 nm to 70 nm, for example.

The liquid crystal element 5 of the present embodiment has several tens to hundreds of pixel regions, each of which is defined as a region where the common electrode 14 and each pixel electrode 13 overlap in a plane view, and these pixel regions are arranged in a matrix. In the present embodiment, the shape of each pixel region is configured to be a square, for example, but the shape of each pixel region can be arbitrarily set, such as a mixture of rectangular and square shapes. The common electrode 14, each pixel electrode 13, and each inter-pixel electrode 15 are connected to the driver 4 via each wiring part 16 and the like, and are statically driven, for example.

With reference to FIG. 3, the configurations of each pixel electrode, each inter-pixel electrode, and each wiring part 16 will be described. In the present embodiment, each pixel electrode 13 is arranged in three columns along a Y direction, and an arbitrary number of pixel electrodes 13 are arranged along a X direction. Here, regarding each pixel electrode 13, the one in the first column from the top in the figure is referred to as pixel electrode 13a, the one in the second column is referred to as pixel electrode 13b, and the one in the third column is referred to as pixel electrode 13c. Further, regarding the inter-pixel electrodes 15, the one which corresponds to the pixel electrode 13a in the first column is referred to as inter-pixel electrode 15a, the one which corresponds to the pixel electrode 13b in the second column is referred to as inter-pixel electrode 15b, and the one which corresponds to the pixel electrode 13c in the third column is referred to as inter-pixel electrode 15c. Furthermore, regarding the wiring part 16, the one which corresponds to the pixel electrode 13a and the inter-pixel electrode 15a in the first column is referred to as wiring part 16a, the one which corresponds to the pixel electrode 13b and the inter-pixel electrode 15b in the second column is referred to as wiring part 16b, and the one which corresponds to the pixel electrode 13c and the inter-pixel electrode 15c in the third column is referred to as wiring part 16c.

Each pixel electrode 13a is connected to the lower layer side of the inter-pixel electrode 15a and the wiring part 16a via a through hole 20a provided in the insulation layer 17. As a result, the pixel electrode 13a, the inter-pixel electrode 15a, and the wiring part 16a are brought to the same electric potential. As shown in the figure, each through hole 20a has a substantially triangular outer edge shape in a plane view, and is provided corresponding to one of the four corners (upper left corner in the figure) of each pixel electrode 13a in a plane view. Here, note that the plane view shape of the through hole 20a is not limited to a substantially triangular shape, and may be a polygon, a circle, an ellipse, or the like. Further, although a case is shown where the through hole 20a is provided at one of the four corners of each pixel electrode, the through hole can be provided at any arbitrary position such as the center of the pixel electrode.

Similarly, each pixel electrode 13b is connected to the lower layer side of the inter-pixel electrode 15b and the wiring part 16b via a through hole 20b provided in the insulation layer 17. As a result, the pixel electrode 13b, the inter-pixel electrode 15b, and the wiring part 16b are brought to the same electric potential. Similarly, each pixel electrode 13c is connected to the lower layer side of the inter-pixel electrode 15c and the wiring part 16c via a through hole 20c provided in the insulation layer 17. As a result, the pixel electrode 13c, the inter-pixel electrode 15c, and the wiring part 16c are brought to the same electric potential.

Each inter-pixel electrode 15a is arranged so as to overlap the gap between two pixel electrodes 13a adjacent to each other in a X direction in a plane view. In the present embodiment, each inter-pixel electrode 15a is arranged such that its own left outer edge in a plane view and the right outer edge of the pixel electrode 13a disposed on its own left side are approximately at the same position in a vertical direction. Similarly, each inter-pixel electrode 15b is arranged so as to overlap the gap between two pixel electrodes 13b adjacent to each other in the X direction in a plane view, and is arranged so that its partial region partially overlaps with the pixel electrode 13b on its own right side. Similarly, each inter-pixel electrode 15c is arranged so as to overlap the gap between two pixel electrodes 13c adjacent to each other in the X direction in a plane view, and is arranged so that its partial region partially overlaps with the pixel electrode 13c on its own right side.

Each wiring part 16a is connected to one of the inter-pixel electrodes 15a, and extends upward in the figure. In the present embodiment, each wiring part 16a is integrally provided with the same width as the corresponding inter-pixel electrode 15a. Each wiring part 16a is connected to the driver 4.

Each wiring part 16b is connected to one of the inter-pixel electrodes 15b, and extends upward in the figure. Each wiring part 16b is connected to the driver 4. In the present embodiment, in a plane view, each wiring part 16b has a partial region that partially overlaps with the pixel electrode 13b adjacent in the X direction with respect to the inter-pixel electrode 15b connected to itself, a partial region arranged between the pixel electrode 13b and the pixel electrode 13a adjacent thereto in the Y direction, and a partial region arranged to overlap the pixel electrode 13a, where these partial regions are provided integrally.

In each wiring part 16b, the partial region arranged between the two pixel electrodes 13a and 13b adjacent to each other in the Y direction also functions as an inter-pixel electrode arranged between these pixel electrodes 13a and 13b. Thereby, the region that essentially functions as a pixel region can be expanded.

Each wiring part 16c is connected to one of the inter-pixel electrodes 15c, and extends upward in the figure. Each wiring part 16c is connected to the driver 4. In the present embodiment, in a plane view, each wiring part 16c has a partial region that partially overlaps with the pixel electrode 13c adjacent in the X direction with respect to the inter-pixel electrode 15c connected to itself, a partial region arranged between the pixel electrode 13c and the pixel electrode 13b adjacent thereto in the Y direction, a partial region arranged to overlap this pixel electrode 13b with the insulation layer 17 in between, a partial region arranged to overlap the pixel electrode 13b and the pixel electrode 13a adjacent in the Y direction with the insulation layer 17 in between; and a partial region arranged between the pixel electrode 13a and the pixel electrode 13b, where these partial regions are provided integrally.

In each wiring part 16c, the partial region arranged between the two pixel electrodes 13b and 13c adjacent in the Y direction also functions as an inter-pixel electrode arranged between these pixel electrodes 13b and 13c. Thereby, the region that essentially functions as a pixel region can be expanded.

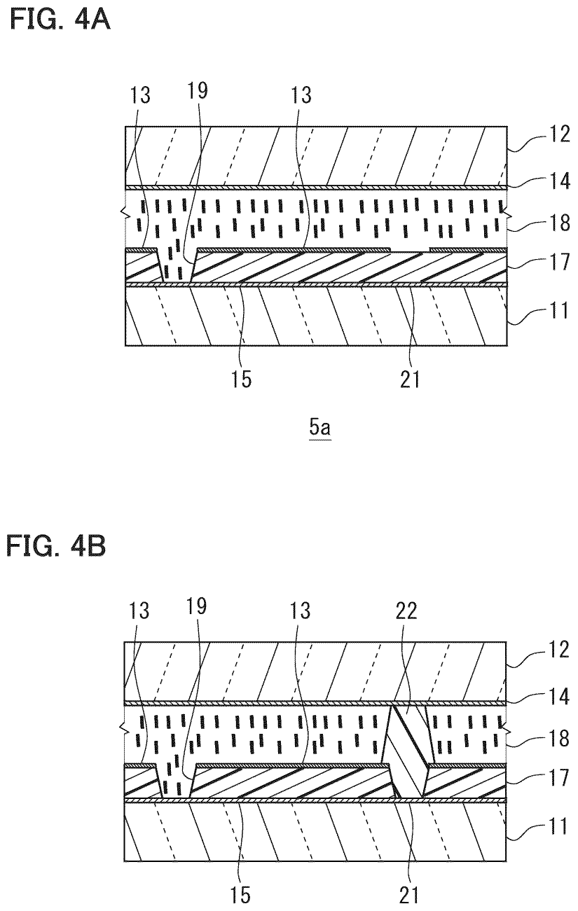

Here, when a voltage is applied to the pixel electrode 13c to cause the region to become a light transmissive state, since the same voltage is also applied to a partial region 21 of the wiring part 16c, this region also becomes a light transmissive state. At this time, for example, if each of the regions corresponding to the pixel electrode 13a and the pixel electrode 13b is in a non-transmissive state (or a low transmissive state), then the light transmissive state of the partial region 21 may become visible as a bright spot. This may be resolved by having a portion of the insulation layer 17 which corresponds to the partial region 21 to remain, as the liquid crystal element 5a of a modified working example shown in FIG. 4A, for example. Further, this may be resolved by providing columnar spacers (column bodies) 22 made of resin or the like so as to partially overlap the partial region 21, as the liquid crystal element 5b of a modified working example shown in FIG. 4B. Here, note that FIG. 4A and FIG. 4B each corresponds to a cross section taken along line c-c shown in FIG. 3. Further, configurations common to the liquid crystal element 5 of the embodiment described above and each of the liquid crystal elements 5a and 5b of the modified working example are given the same reference numerals, and detailed explanation thereof will be omitted.

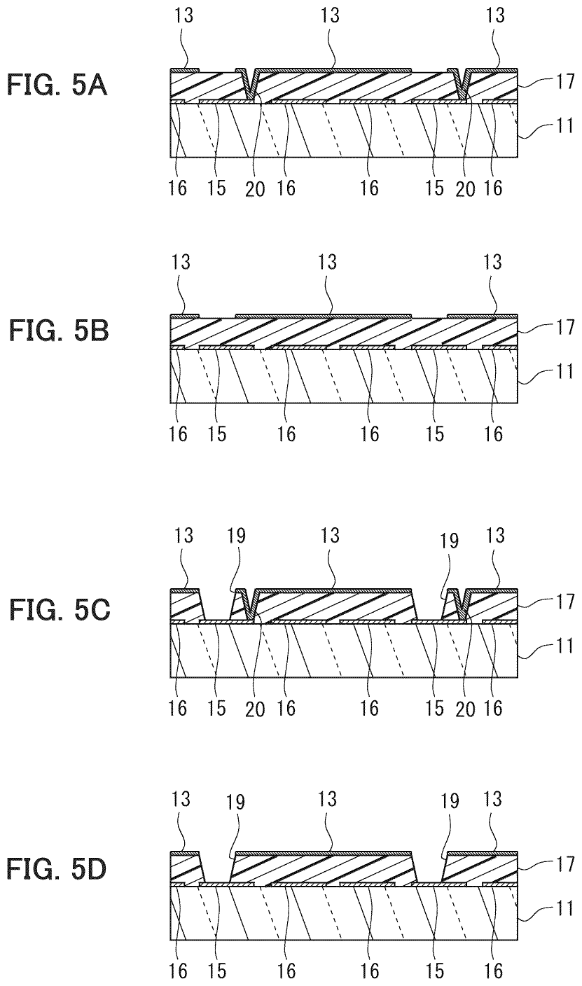

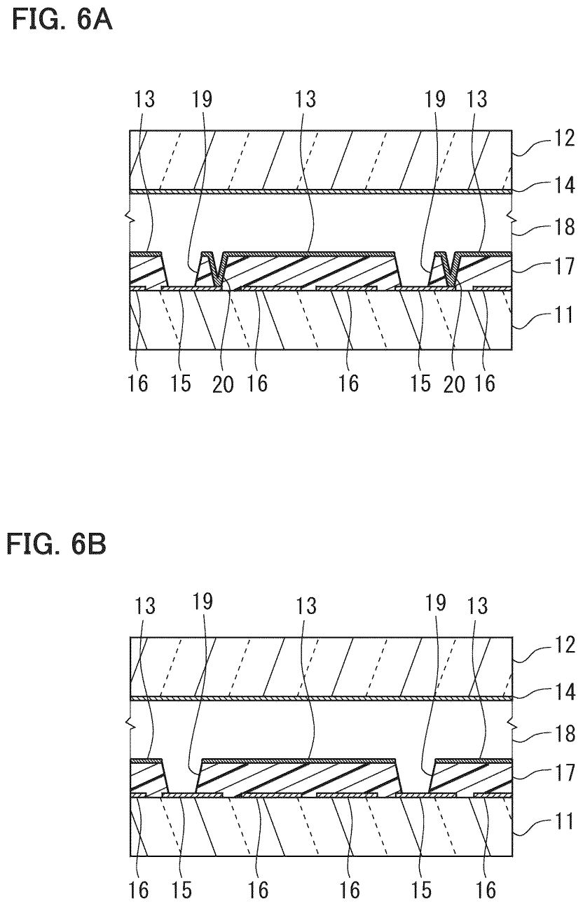

FIG. 5A to FIG. 5D, FIG. 6A, and FIG. 6B are diagrams for explaining a manufacturing method of the liquid crystal element of the present embodiment. Here, note that FIG. 5A, FIG. 5C, and FIG. 6A correspond to the cross section taken along line a-a in FIG. 3 as described above, and FIG. 5B, FIG. 5D, and FIG. 6B correspond to the cross section taken along line b-b in FIG. 3 as described above. Further, in the following description, preferred examples of materials, film thicknesses, film forming methods, etc. for forming various films and layers are shown, but these are merely examples.

A first substrate 11 is prepared, and each inter-pixel electrode 15 and each wiring part 16 are formed on one surface side of the first substrate 11 (refer to FIG. 5A and FIG. 5B). For example, each inter-pixel electrode 15 and each wiring part 16 can be obtained by forming an ITO film by a sputtering method and patterning the ITO film by using photolithography technique. Similarly, a second substrate 12 is prepared, and a common electrode 14 is formed on one surface side of the second substrate 12.

Next, an insulation layer 17 is formed so as to cover each inter-pixel electrode 15 and each wiring part 16 (refer to FIG. 5A and FIG. 5B). For example, a SiNx film (for example, a silicon nitride film such as a Si₃N₄ film) having a film thickness of about 0.3 μm is formed by plasma CVD method. Furthermore, a contact hole 20 is formed. The contact hole 20 can be formed using a reactive ion etching method by use of fluorocarbon gas, for example. It is preferable that the contact hole 20 is formed to have a forward tapered shape such that the width (diameter) decreases as it approaches the first substrate 11, and it is particularly preferable that the tapered shape is 40° to 60°. Thereby, film formability of the contact hole 20 area is improved when forming the pixel electrode 13, which will be described next.

Here, note that as the material for forming the insulation image 17, other inorganic insulation materials (for example, silicon oxide films such as SiO₂) or organic insulation materials (for example, acrylic materials) may be used.

Next, each pixel electrode 13 is formed on one surface side of the insulation layer 17 (refer to FIG. 5A and FIG. 5B). Again, for example, each pixel electrode 13 can be obtained by forming an ITO film by a sputtering method and patterning the ITO film using photolithography technique. At this time, a part of the pixel electrode 13 is also formed within the above-described contact hole 20, and the lower layer side of the inter-pixel electrode 15 or the wiring part 16 is connected to the pixel electrode 13.

Next, a portion of the insulation layer 17 that exists between each pixel electrode 13 in a plane view is removed (refer to FIG. 5C and FIG. 5D). This process is preferably carried out using each pixel electrode 13 as an etching mask, for example, and using reactive ion etching method with the use of fluorocarbon gas, for example. Thereby, opening parts 19 can be provided with high accuracy in accordance with the positions of each pixel electrodes 13. Further, it is preferable that each opening part 19 formed here has a forward tapered shape such that the width (diameter) decreases as it approaches the first substrate 11, and it is particularly preferable that the tapered shape is 40° to 60°.

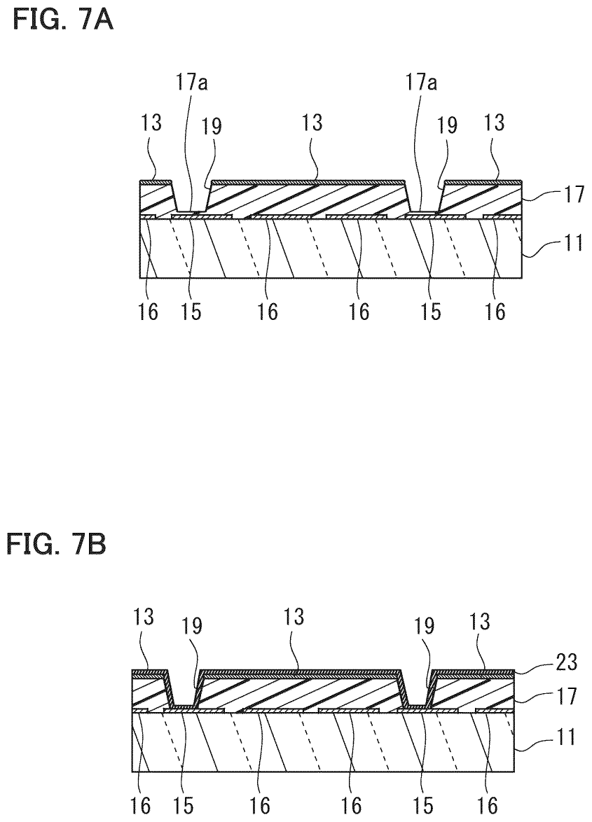

Here, note that in this process, instead of completely removing the portion of the insulation layer 17 between each pixel electrode 13 so as to completely expose each pixel electrode 15, as the modified working example shown in FIG. 7A, an insulation layer (thin layer part) 17a may be caused to remain at the bottom of the opening part 19 to cover each inter-pixel electrode 15 (or wiring part 16). That is, as an insulation film for the inter-pixel electrode 15, an insulation layer 17a having a film thickness thinner than the insulation layer 17 can be provided to the region that does not overlap the image electrode 13. Formation of the insulation layer 17a can be realized by controlling the etching time and the like. In this case, the film thickness of the insulation layer 17a is relatively thinner than the original insulation layer 17, for example, preferably about 30% (0.3 times), or preferably 60% (0.6 times) or less.

Further, as the modified working example shown in FIG. 7B, after this process, on the first substrate 11, it is also preferable to form an insulation layer 23 made of a SiO₂ film or the like so as to cover the insulation layer 17, the inner wall of the opening part 19, each inter-pixel electrode 15 exposed at the bottom thereof, and each wiring part 16. In this case, an insulation film 17a as shown in FIG. 7A can also be included. That is, the insulation film 23 is provided so as to continuously cover the pixel electrode 13 and the opening part 19 (the inter-pixel electrode 15 exposed within the opening part 19 or an insulation layer 17a). The insulation layer 23 can be formed, for example, by flexographic printing. The film thickness can be 500 Å to 800 Å, for example. In this case, by forming the opening part 19 to be a forward tapered shape, film formability of the insulation layer 23 can be improved. Similarly, it is also preferable to form an insulation layer on the second substrate 12 so as to cover the common electrode 14. Here, note that when providing such an insulation layer 23, it is more preferable to form the above-described insulation layer 17 using an inorganic material. This is because inorganic materials generally has higher heat resistance, so that it is possible to prevent the insulation layer 17 from deteriorating due to heat treatment when forming the insulation layer 23 and the like.

Next, an alignment film (not shown) is formed on each surface side of the first substrate 11 and the second substrate 12. Here, a vertical alignment film is formed by flexographic printing, an inkjet method, etc., and after heat treatment is performed, an alignment treatment such as rubbing is performed. The film thickness of the alignment film can be 500 Å to 800 Å, for example. By forming the opening part 19 to be a forward tapered shape, film formability of the alignment film can be improved.

Next, a seal material (not shown) for surrounding and sealing the liquid crystal layer 18 is formed on one surface side of either of the first substrate 11 or the second substrate 12 (for example, the first substrate 11). Further, a gap control material is sprayed on one surface side of the other of the first substrate 11 or the second substrate 12 (for example, the second substrate 12). Here, gap control material having a particle size of about 3 μm to 6 μm can be used, for example. Here, note that spacers such as resin columns may be provided instead of the gap control material.

Next, the first substrate 11 and the second substrate 12 are bonded together with each of their one side facing the other to form a cell (refer to FIG. 6A and FIG. 6B). For example, the seal material is cured by heat treatment or light irradiation treatment with the first substrate 11 and the second substrate 12 placed one on top of the other, and with constant pressure applied using a press or the like. At this time, the first substrate 11 and the second substrate 12 can be arranged such that the alignment treatment directions (for example, rubbing directions) for each are alternated. Here, note that the alignment treatment directions may be the same direction or may be intersecting directions, and may be appropriately selected depending on the operation mode in which the liquid crystal layer 18 is operated.

Thereafter, the liquid crystal layer 18 is formed by filling a liquid crystal material between the first substrate 11 and the second substrate 12, and an injection port is sealed by a sealing member. Thereby, the liquid crystal element 5 shown in FIG. 2A and FIG. 2B is completed. Here, note that although vacuum injection method is assumed here as a method for filling the liquid crystal material, ODF method may also be used.

Next, the effect achieved by the liquid crystal element 5 of the present embodiment will be described.

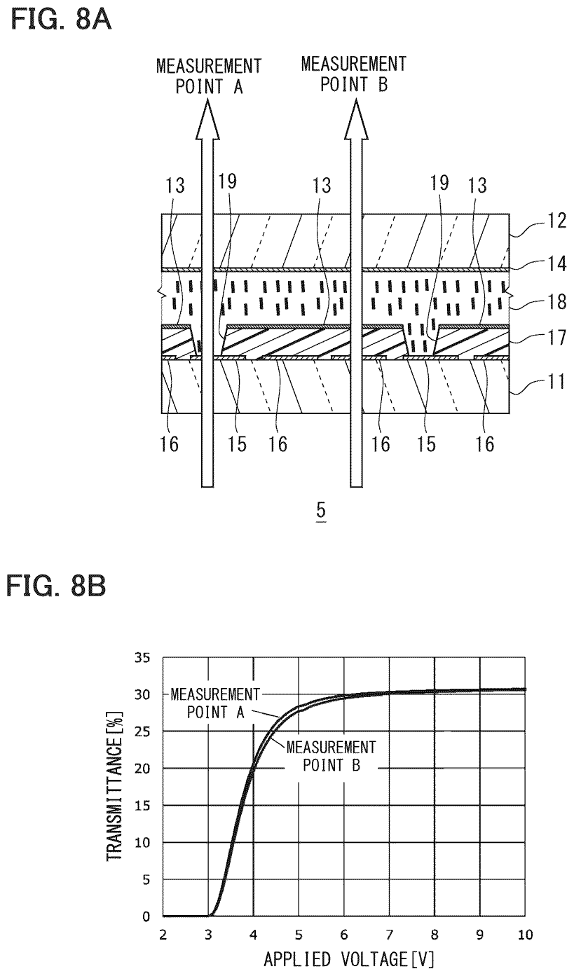

FIG. 8A is a diagram for explaining measurement points (measurement locations) of electro-optical characteristics of a liquid crystal element. FIG. 8B is a diagram showing a measurement example of the electro-optical characteristics. As shown in FIG. 8A, relationship between applied voltage and transmittance at measurement point A which passes through the inter-pixel electrode 15 but not through the insulation layer 17 and measurement point B which passes through the pixel electrode 13 and the insulation layer 17 is measured, and the measured example is shown in FIG. 8B.

As shown in FIG. 8B, at measurement points A and B, it can be seen that the characteristics especially near the threshold value are almost the same. This is because, by providing the opening part 19 in the insulation layer 17, approximately the same voltage is applied to the liquid crystal layer 18 at both measurement points A and B. Here, it is common knowledge among those skilled in the art that the threshold voltage does not depend on the layer thickness of the liquid crystal layer 18. A slight difference in transmittance is seen in a range where the applied voltage is relatively high, but this is considered to be caused by the difference in the layer thickness of the liquid crystal layer due to the presence or absence of the insulation layer 17. The insulation layer 17 has a layer thickness of about 0.3 μm, for example, and the difference in the liquid crystal layer thickness can be said to be very small. Therefore, in consideration of obtaining halftone transmittance, it can be said that the transmittance for the same applied voltage is approximately equal at measurement points A and B. That is, regardless of the applied voltage, it is possible to realize a lighting apparatus that is less likely to create dark lines or bright lines in the portion corresponding to the inter-pixel electrode 15. Here, note that, in principle, similar effect can be achieved in a lighting apparatus using liquid crystal elements in the modified working examples in which the insulation layer 17a as described above is caused to remain (refer to FIG. 7A) or in which the insulation layer 23 is provided over the entire structure (refer to FIG. 7B).

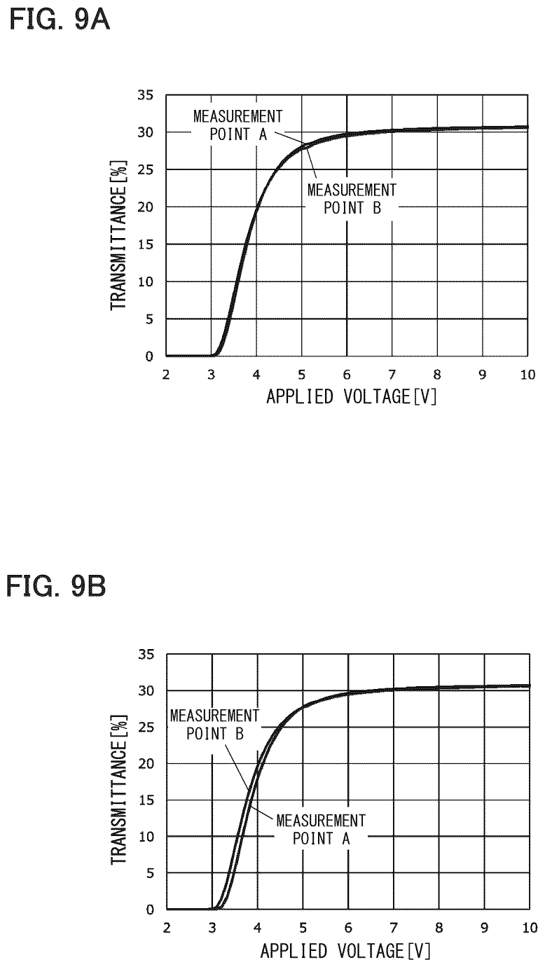

FIG. 9A and FIG. 9B are diagrams showing measurement examples of electro-optical characteristics of a liquid crystal element of a modified working example in which the insulation layer (thin layer part) is caused to remain (refer to FIG. 7A). Here, note that measurement points A and B are the same as those shown in FIG. 8A described above. As shown in each figure, by causing the insulation layer 17a to remain in the portion corresponding to the inter-pixel electrode 15, the effect of correcting the transmittance difference between measurement points A and B can be achieved. In the following, the reason for this will be discussed.

Since the layer thickness of the liquid crystal layer 18 is different between measurement point A and measurement point B, a corresponding difference in transmittance may occur. Generally, when the liquid crystal layer 18 is in vertical alignment mode, there is layer thickness dependency in the transmittance. For example, consider a vertically aligned liquid crystal element where xy chromaticity value becomes a white color when its liquid crystal layer is formed at a layer thickness of 4 μm. When the liquid crystal layer thickness is caused to become slightly thicker, there is a tendency for the xy chromaticity value to shift to a yellow color side while the transmittance becomes slightly higher. As shown in FIG. 8B, the above-described difference in transmittance between measurement points A and B in the electro-optical characteristics is considered to be affected by this, albeit very slightly.

On the contrary, when the insulation layer 17a exists at a position corresponding to measurement point A, the threshold value at measurement point A becomes a little higher. This is because the applied voltage is divided between the insulation layer 17a and the liquid crystal layer 18. For example, in order to simplify the calculation, assuming that permittivity of the insulation layer 17a and permittivity of the liquid crystal layer 18 are approximately equal, the voltage (divided voltage) applied to the liquid crystal layer 18 at measurement point A can be considered simply as the layer thickness ratio between the layer thickness of the liquid crystal layer 18 and the layer thickness of the insulation layer 17a at measurement point A.

FIG. 9A shows the electro-optical characteristics when the insulation layer 17a is formed at a layer thickness of 0.09 μm. The threshold value of the liquid crystal layer 18 is approximately 1.02 times higher than that in the case without the insulating layer 17a, and almost the same transmittance is obtained at measurement points A and B over the entire range of the applied voltage. Further, FIG. 9B shows the electro-optical characteristics when the insulation layer 17a is formed at a layer thickness of 0.17 μm. The threshold value of the liquid crystal layer 18 is approximately 1.04 times higher than that in the case without the insulating layer 17a. Although the difference in transmittance is suppressed compared to the previous example and is within an acceptable range, a slight difference in transmittance is observed in a low range of applied voltage (approximately in the range of 3 V to 4.5 V). Since the layer thickness of the insulating layer 17 is 0.3 μm, it can be said that it is preferable that the layer thickness of the insulating layer 17a is formed to remain at about 30% of the layer thickness of the original insulating layer 17, and is preferably about 60% or less.

According to the embodiments as described above, in a liquid crystal element used in a vehicle lighting system (lighting apparatus) in which the light distribution pattern can be freely controlled, it becomes possible to enhance the appearance of the light distribution pattern while simplifying the manufacturing process of the liquid crystal element.

Here, note that the present disclosure is not limited to the content of the embodiment described above, and can be implemented with various modifications within the scope of the gist of the present disclosure. For example, the configurations of the vehicle lighting system shown in the above-described embodiments are an merely examples and is not limited thereto. Further, in the above-described embodiments, an example has been described in which the present invention is applied to a system that selectively irradiates light to the front of a vehicle, but the scope of application of the present invention is not limited thereto. For example, the present invention may be applied to a system that emits light diagonally in front of a vehicle depending on the direction of travel of the vehicle, a system that adjusts the optical axis of the headlight depending on a vehicle's longitudinal tilt, and a system that electronically switches high beam and low beam of the headlight of a vehicle. Furthermore, the present invention may be applied not only to vehicle applications but also to lighting apparatus in general.

### REFERENCE SIGNS LIST

1: Light source
2: Camera
3: Controller
4: Driver
5, 5a, 5b: Liquid crystal element
6a, 6b: Polarizer
7: Projection lens
11: First substrate
10: Second substrate
13: Pixel electrode
14: Common electrode
15: Inter-pixel electrode
16: Wiring part
17, 17a: Insulation layer
18: Liquid crystal layer
19: Opening part
20: Contact hole

1. A liquid crystal element comprising:
a first substrate and a second substrate arranged to face each other;
a liquid crystal layer arranged between the first substrate and the second substrate;
a plurality of auxiliary electrodes arranged on one surface side of the first substrate facing the liquid crystal layer;
an insulation layer arranged on the one surface side of the first substrate so as to cover the plurality of first electrodes;
a plurality of pixel electrodes arranged between the insulation layer of the first substrate and the liquid crystal layer; and
a counter electrode arranged on one surface side of the second substrate facing the liquid crystal layer;
wherein the plurality of pixel electrodes are being arranged with a gap provided therebetween in at least one direction in a plane view,
wherein the plurality of auxiliary electrodes is being arranged so as to respectively overlap with the gap between the adjacent pixel electrodes in a plane view, and is connected to one of the adjacent pixel electrodes via a contact hole provided in the insulation layer, and
wherein the insulation layer has an opening part in a portion corresponding to the gap between the adjacent pixel electrodes.

2. The liquid crystal element according to claim 1,
wherein the insulation layer has substantially the same shape in a plane view as the plurality of pixel electrodes, and a portion in which each pixel electrode does not exist corresponds to the opening part.

3. The liquid crystal element according to claim 1,
wherein the insulation layer is composed of a silicon nitride film or a silicon oxide film.

4. The liquid crystal element according to claim 1,
wherein the opening part of the insulation layer has a forward tapered shape whose width or diameter decreases as it approaches the one surface of the first substrate.

5. The liquid crystal element according to claim 1,
wherein the insulation layer has a thin layer part that covers a part of the auxiliary electrode at the bottom of the opening part, and has a film thickness that is relatively smaller than a portion corresponding to the plurality of pixel electrodes.

6. The liquid crystal element according to claim 5,
wherein the layer thickness of the thin layer part is 0.3 times or more and 0.6 times or less than the layer thickness of the portion corresponding to the plurality of pixel electrodes of the insulation layer.

7. The liquid crystal element according to claim 1 further comprising a second insulation layer that continuously covers the plurality of pixel electrodes and the opening part.

8. A lighting apparatus comprising:
a liquid crystal element according to claim 1,
a light source that causes light to enter the liquid crystal element; and
a lens that condenses the light that passes through the liquid crystal element.
